(19) United States
(12) Patent Application Publication
(10) Pub. No.: US 2010/0221697 A1
(43) Pub. Date: Sep. 2, 2010

(54) COMPOSITION FOR PRESERVING PLATELETS AND METHOD OF USING AND STORING THE SAME

(75) Inventor: Lakshman R. SEHGAL, Monarch Beach, CA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: BioVec Transfusions, LLC, Chicago, IL (US)

(21) Appl. No.: 12/770,389

(22) Filed: Apr. 29, 2010

Related U.S. Application Data
(63) Continuation-in-part of application No. 11/330,132, filed on Jan. 12, 2006.
(60) Provisional application No. 60/643,107, filed on Jan. 12, 2005.

(51) Int. Cl. A01N 1/02

(52) U.S. Cl. 435/2

(57) ABSTRACT

The present invention relates to a method for preserving and storing platelets. The method includes the steps of admixing inactivated, functional platelets with a preservative composition comprising an effective amount of one or more pharmaceutically acceptable inhibitors of platelet activation to form preserved platelets, storing the preserved platelets at low temperature, and removing the one or more inhibitors of platelet activation from the preserved platelets by diafiltration prior to transfusion.

This application is a continuation-in-part application of U.S. patent application Ser. No. 11/330,132, filed Jan. 12, 2006, which claims priority from U.S. Provisional Application Ser. No. 60/643,107 filed Jan. 12, 2005. The entirety of that provisional application is incorporated herein by reference.

### FIELD

The present invention relates to a composition and method for extending the shelf-life of platelets. More particularly, the present invention relates to a method for preserving platelet in a preservative composition comprising one or more inhibitors of platelet activation aggregation and removing the one or more inhibitors by diafiltration prior to transfusion. The method is particularly useful in extending life and maintaining the efficacy of platelets.

### BACKGROUND

When blood vessels are damaged, cell fragments released from the bone marrow, called platelets, adhere to the walls of blood vessels and form clots to prevent blood loss. It is important to have adequate numbers of normally functioning platelets to maintain effective clotting, or coagulation, of the blood. Occasionally, when the body undergoes trauma, or when the platelets are unable to function properly, it is necessary to replace or transfer platelet components of blood into a patient. Most commonly, platelets are obtained from volunteer donors either as a component of a whole blood unit, or via plateletpheresis (withdrawing only platelets from a donor and re-infusing the remaining of the blood back into the donor). The platelets then are transferred to a patient as needed, a process referred to as “platelet transfusion.”

Platelet transfusion is indicated under several different scenarios. For example, an acute blood loss, either during an operation or as a result of trauma, can cause the loss of a large amount of platelets in a short period of time. Platelet transfusion is necessary to restore a normal ability to control blood flow, or haemostasis. In a medical setting, an individual can develop a condition of decreased number of platelets, a condition known as thrombocytopenia. The condition can occur as a result of chemotherapy, and requires platelet transfusion to restore normal blood clotting.

Unlike red blood cells, which can be stored for forty-five (45) days, platelets can be stored for only five to seven days. The short storage term, or shelf-life, of the platelets severely limits the useful span for a platelet supply. A consequence of this short shelf-life is that platelets must be collected close to their time of use, which makes it extremely difficult to coordinate platelet collection and platelet supply.

One reason platelets have such short shelf-life is that platelets become activated during the process of collection. The activation process leads to externalization of platelet canalicular surfaces exposing receptor sites, such as GPIIb/IIIa. Phosphatidylserine residues on activated platelets tend to cause platelet aggregation, which results in cell death (i.e., apoptosis) upon re-infusion into patients. Thus, a platelet functional half-life is significantly reduced.

Another reason platelets have a short shelf-life is that an inadequate oxygen supply alters the metabolic activity of the platelets. In an environment lacking a sufficient oxygen supply, the platelets undergo an anaerobic mechanism leading to accumulation of lactic acid. The increased concentration of lactic acid causes a drop in pH, and results in cell death. Although platelets can be stored in gas permeable bags using a shaker bath under a stream of air to help overcome this problem, such storage methods are costly and extremely inefficient and inadequate in meeting the oxygen requirements of the stored platelets.

Platelet sterility is difficult to maintain because platelets cannot be stored at low temperatures, for example 4° C. to 5° C. A low storage temperature for the platelets initiates an activation process within the platelets that leads to aggregation and cell death. Bacterial growth in the platelet medium at suitable storage temperatures, e.g., room temperature, can lead to an unacceptable occurrence of bacterial contamination in platelets used for transfusion. As a result, the Food and Drug Administration (FDA) limits the storage time of platelets to five (5) days, thereby safeguarding the transfusion supply from bacterial contamination.

Many sterilization methods have been suggested. Platelet compositions typically can be sterilized by radiation, chemical sterilization, or a combination thereof. For example, a method of inactivating viral and bacterial blood contaminants using a quinoline as a photosensitizer is disclosed in U.S. Pat. No. 5,798,238. Other classes of photosensitizers are, for example, psoralens, coumarins, or other polycyclic ring compounds, as disclosed in U.S. Pat. No. 5,869,701; quinolones, as disclosed in U.S. Pat. No. 5,955,256; free radical and reactive forms of oxygen, as disclosed in U.S. Pat. Nos. 5,981,163 and 6,087,141; and phenothiazin-5-ium dyes, as disclosed in U.S. Pat. No. 6,030,767. U.S. Pat. No. 6,106,773 discloses another method for disinfecting biological fluids, including platelets, by contacting the biological fluids with an iodinated matrix material.

These sterilization methods, however, do not extend storage life of platelet but, on the contrary, appear to significantly decrease platelet functionality by activating platelets. To effectively extend the shelf life of platelets, not only are sterilization methods for preventing contamination of the platelets important, but it also would be beneficial to provide improved methods to protect the platelets during the sterilization. It would also be beneficial to provide a convenient, effective preservative solution for prolonging the shelf-life of the platelets, while maintaining the functionality and freshness of the platelets. In addition, it would be beneficial to provide a method or composition for storing platelets that requires less management of the surrounding platelet storage environment.

### SUMMARY

The present invention relates to a method for preserving and storing platelets. The method includes the steps of admixing inactivated, functional platelets with a preservative composition comprising an effective amount of one or more pharmaceutically acceptable inhibitors of platelet activation to form preserved platelets; storing the preserved platelets at a low temperature; and removing the one or more inhibitors of platelet activation from the preserved platelets by diafiltration prior to transfusion. The low temperature is in the range of about −20° C. to about 12° C. The preservative method permits an extended storage of platelets while maintaining blood clotting properties without affecting the half-life of the platelets in circulation after transfusion.

In one embodiment, the one or more inhibitors of platelet activation include an anticoagulant and an antiplatelet agent.

In a related embodiment, the antiplatelet agent is capable of reversibly blocking platelet activation and/or aggregation by blocking sites on the platelet surface.

In another related embodiment, the antiplatelet agent is selected from the group consisting of a compound that binds to, or associates with a GPIIb/IIIa receptor site, a non-steroidal anti-inflammatory drug (NSAID), a calcium channel blocker, α-blocker, β-adrenergic blocker, and mixtures thereof.

In another related embodiment, the anticoagulant is a compound that reversibly inhibits factor Xa, or factor IIa, or both.

In another related embodiment, the anticoagulant is a short-to-ultrashort acting Xa inhibitor.

In another related embodiment, the anticoagulant is a short-to-ultrashort acting IIa inhibitor.

In another embodiment, the oxygen carrier is a hemoglobin-based oxygen carrier.

In a related embodiment, the oxygen carrier is selected from the group consisting of hemoglobin, ferroprotoporphyrin, perfluorochemicals, and mixtures thereof.

In another related embodiment, each the hemoglobin-based oxygen carrier is substantially free of red cell membrane contaminants.

In another embodiment, the preserved platelets are stored in an oxygen-permeable bag.

In another embodiment, the preserved platelets are stored in an oxygen-impermeable bag.

In another embodiment, the platelet preservation composition further comprises a short or ultra-short acting anti-microbial agent.

In another embodiment, the low temperature is in the range of about 0° C. to about 12° C.

In another embodiment, the low temperature is in the range of about 4° C. to about 12° C.

In yet another embodiment, the low temperature is in the range of about 4° C. to about 8° C.

### BRIEF DESCRIPTION OF THE FIGURES

FIGS. 1A and 1B are the diagrams of TEG and tracing showing the initiation and completion phases of platelet-fibrin clot initiated by TF (25 ng) under shear in human whole blood (WB).

FIG. 2A shows the initiation of platelet/fibrin clot by tissue factor (TF) in human blood using thromboelastography (TEG). FIG. 2B shows the inhibition of platelet/fibrin clot induced by TF with different concentrations of c7E3 (antibody against platelet GPIIb/IIIa). FIG. 2C shows comparable effect of c7E3 on platelet aggregation and platelet/fibrin clot.

FIG. 3 is a diagram showing a protocol of GP IIb/IIIa antagonists and platelet fibrinogen binding short to ultra-short acting GP IIb/IIIa antagonists including those that are separated from platelet upon size exclusion chromatography.

FIG. 4 shows thromboelastogram tracings of platelets stored under current methods (black tracing) compared with platelets stored with the Biovec preservative (green tracing). The data was obtained following one day of storage. The prolonged time with the Biovec platelet before the initiation of clot formation reflects incomplete removal of the inhibitors.

FIG. 5 shows data following one day of storage of a second set of split platelet concentrate units. The control is again represented by the black tracing and the Biovec test unit by the green tracing. In this instance there has been complete removal of the platelet inhibitors.

FIG. 6 shows thromboelastograms of the same units shown in FIG. 4 but after 7 days of storage following standard Blood Bank practices.

FIG. 7 shows thromboelastograms of the same units shown in FIG. 5 but after storage for 7 days.

FIG. 8 shows response of platelets stored in the Biovec preservative, to thrombin related activated peptide (TRAP) test using the multiplate analyzer. This was measured after one day of storage under standard blood bank procedures.

FIG. 9 shows response of the split control unit to the TRAP test. This measurement was also made after one day of storage.

FIG. 10 shows response to TRAP of a second split platelet unit stored in the Biovec preservative solution.

FIG. 11 shows response to TRAP of the matched split platelet unit stored with the currently available preservative solution.

FIG. 12 shows response to collagen as agonist, of platelets stored for one day in the Biovec preservative solution.

FIG. 13 shows response to collagen of the matched split control unit stored in currently available medium.

FIG. 14 shows response to collagen of the second test platelet unit after one day of storage in the Biovec preservative solution.

FIG. 15 shows response to collagen of the matched split control platelet unit after one day of storage.

FIG. 16 shows response to the TRAP test of the platelet unit stored in the Biovec preservative solution after 7 days of storage. This test unit had an identical response to TRAP on one day after storage.

FIG. 17 shows response to the TRAP test of the matched split control platelet unit after 7 days of storage under standard Blood Bank conditions. Compared to its response one day after storage (63 AU), there was no response to the same agonist.

FIG. 18 shows response to the TRAP test of the second platelet unit stored in the Biovec preservative solution. Once again, its response was essentially unchanged from its response one day after storage.

FIG. 19 shows response to the TRAP test of the matched control platelet unit stored in the currently available preservative solution. There is no response to the agonist.

FIG. 20 shows response to collagen of the split platelet unit stored in the Biovec preservative solution. Once again, the response after 7 days of storage appears to be essentially unchanged from its response one day after storage.

FIG. 21 shows response to the collagen test of the matched control split platelet unit. Once again platelets stored with currently available preservative solution are unresponsive to agonists after 7 days in storage.

FIG. 22 shows response to the collagen test of the second split platelet unit stored in the Biovec solution. Here again, little difference is noted from the response observed after one day of storage.

FIG. 23 shows response to the collagen test of the matched split platelet unit stored in the currently available preservative solution. Just like the other control unit, there is no response to the agonist after 7 days of storage.

### DETAILED DESCRIPTION OF THE INVENTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

The present invention relates to a method for preserving platelet. The method includes the steps of admixing inactivated, functional platelets with a preservative composition comprising an effective amount of one or more pharmaceutically acceptable inhibitors of platelet activation or aggregation to form preserved platelets, storing the preserved platelets at low temperature, and removing the one or more inhibitors of platelet activation from the preserved platelets by diafiltration prior to use.

The term “pharmaceutically acceptable” as used herein refers to a substance that complies with the regulations enforced by the FDA regarding the safety of use in a human or animal subject or a substance that has passed the FDA human safety trials. The term “pharmaceutically acceptable antiplatelet agent”, for example, refers to an active agent that prevents, inhibits, or suppresses platelet adherence and/or aggregation, and comports with guidelines for pharmaceutical use as set forth by the FDA.

As used herein, the term “effective amount” refers to a quantity that is capable of achieving an intended effect.

The temperature can be used from about −80° C. to 42° C. As used herein, the term “room temperature” or “ambient temperature” refers to a temperature in the range of 12° C. to 30° C.; the term “body temperature” refers to a temperature in the range of 35° C. to 42° C. The temperature used for platelets storage of the present invention is preferably in a low temperature. The term “low temperature” refers to a temperature in the range of −20° C. to 12° C., preferably in the range of 0° C. to 12° C., more preferably in the range of 4° C. to 12° C., most preferably in the range of 4° C. to 8° C.

Generally, inhibitors of platelet activation or aggregation include anticoagulants and antiplatelet agents. Examples of anticoagulants include, but are not limited to, heparin, heparin substitutes, prothrombopenic anticoagulants, platelet phosphodiesterase inhibitors, dextrans, thrombin antagonists, and mixtures thereof.

Examples of heparin and heparin substitutes include, but are not limited to, heparin calcium, such as calciparin; heparin low-molecular weight, such as enoxaparin and lovenox; heparin sodium, such as heparin, lipo-hepin, liquaemin sodium, and panheprin; and heparin sodium dihydroergotamine mesylate.

Suitable prothrombopenic anticoagulants are, for example, anisindione, dicumarol, warfarin sodium, and the like. More specific examples of phosphodiesterase inhibitors suitable for use in the invention include, but are not limited to, anagrelide, dipyridamole, pentoxifyllin, and theophylline. Examples of dextrans are, for example, dextran 70, such as HYSKON® (CooperSurgical, Inc., Shelton, Conn., U.S.A.) and MACRODEX® (Pharmalink, Inc., Upplands Vasby, Sweden), and dextran 75, such as GENTRAN® 75 (Baxter Healthcare Corporation, Deerfield, Ill., U.S.A.).

The anticoagulants of the present invention also include Xa inhibitors, IIa inhibitors, and mixtures thereof. Various direct Xa inhibitors were synthesized and advanced to clinical development (Phase I-II) for the prevention and treatment of venous thromboembolic disorders and certain settings of arterial thrombosis [Hirsh and Weitz, Lancet, 93:203-241, (1999); Nagahara et al., Drugs of the Future, 20: 564-566, (1995); Pinto et al., 44: 566-578, (2001); Pruitt et al., Biorg. Med. Chem. Lett., 10: 685-689, (2000); Quan et al., J. Med. Chem. 42: 2752-2759, (1999); Sato et al., Eur. J. Pharmacol., 347: 231-236, (1998); Wong et al, J. Pharmacol. Exp. Therapy, 292:351-357, (2000)]. A direct anti-IIa (thrombin) such as melagatran, the active form of pro-drug ximelagatran [Hirsh and Weitz, Lancet, 93:203-241, (1999); Fareed et al., Current Opinion in Cardiovascular, pulmonary and renal investigational drugs, 1:40-55, (1999)]. Additionally, a number of VIIa inhibitors and anti-tissue factors are in pre-clinical and early stage of clinical development. Formulation of zwitterionic short acting GPIIb/IIIa antagonists with small molecules direct Xa inhibitor, IIa inhibitor or mixed Xa and IIa inhibitors as defined by Mousa et al., Athero. Thromb. Vasc. Biol., 2000) would provide an optimal platelet preservation.

In certain embodiments, the anticoagulant is a short-to-ultra short acting anticoagulant. By short or ultra short acting anticoagulant is meant that the anticoagulant is cleared from circulation from 15 minutes to 8 hours, once the infusion of the anticoagulant into the patients is stopped. In one embodiment, the short-to-ultra short acting anticoagulant is a short-to-ultra short acting Xa inhibitor with a circulating half-life of less than 4 hours. Examples of ultra-short acting Xa inhibitors include, but are not limited to, DX-9065a, RPR-120844, BX-807834 and SEL series Xa inhibitors.

DX-9065a is a synthetic, non-peptide, propanoic acid derivative, 571 Da, selective factor Xa inhibitor (Daiichi). It directly inhibits factor Xa in a competitive manner with an inhibition constant in the nanomolar range [Herbert et al., J. Pharmacol. Exp. Ther. 276:1030-1038 (1996); Nagahara et al., Eur. J. Med. Chem. 30(suppl):140s-143s (1995)].

As a non-peptide, synthetic factor Xa inhibitor, RPR-120844 (Rhone-Poulenc Rorer), is one of a series of novel inhibitors which incorporate 3-(S)-amino-2-pyrrolidinone as a central template [Ewing et al., Drugs of Future 24(7):771-787 (1999)]. This compound has a Ki of 7 nM with selectivity >150-fold over thrombin, activated protein C, plasmin and t-PA. It prolongs the PT and αPTT in a concentration-dependent manner, being more sensitive to the αPTT. It is a fast binding, reversible and competitive inhibitor of factor Xa.

BX-807834 has a molecular weight of 527 Da and a Ki of 110 pM for factor Xa as compared to 180 pM for TAP and 40 nM for DX-9065a [Baum et al., Circulation. 98 (17), Suppl 1: 179, (1998)].

The SEL series of novel factor Xa inhibitors (SEL-1915, SEL-2219, SEL-2489, SEL-2711: Selectide) are pentapeptides based on L-amino acids produced by combinatorial chemistry. They are highly selective for factor Xa and potency in the pM range. The Ki for SEL 2711, one of the most potent analogues, is 0.003 M for factor Xa and 40 M for thrombin [Ostrem et al., Thromb. Haemost. 73:1306 (1995); Al-Obeidi and Ostrem., Exp. Opin. Ther. Patents 9(7):931-953 (1999)].

In another embodiment, the short-to-ultra short acting anticoagulant is a short-to-ultra short acting IIa inhibitor. Examples of short-to-ultra short acting anticoagulant include, but are not limited to, DUP714, hirulog, hirudin, melgatran and combinations thereof.

Any agent that reversibly impedes platelet activation and/or aggregation by blocking sites on the platelet surface can be used as the antiplatelet agent in the present invention. As used herein, the term “reversible” or “reversibly” refers to an act, such as binding or associating, that is capable of reverting back to an original condition prior to the act, for example the state of being unbound or disassociated, either with or without the assistance of an additional constituent.

Antiplatelet agents can include, but are not limited to, active agents that bind GPIIb/IIIa sites in a reversible manner and non-steroidal anti-inflammatory drugs (NSAIDs). Examples of suitable antiplatelet agents for binding GPIIb/IIIa sites in a reversible manner are eptifibatide (INTEGRILIN®, Schering-Plough Corporation, Kenilworth, N.J., U.S.A.), orbofiban, xemilofiban, Lamifiban, tirofiban, abciximab, XJ757, DUP728, XR299, bifunctional inhibitors of both GPIIb/IIIa as described in U.S. Pat. No. 5,242,810, P2Y12 receptor antagonist such as prasugrel, cungrelor and AZD6140, second messenger effectors such as “Thrombosol” (Life Cell Corp), linear or novel cyclic RGD peptide analogs, cyclic peptides, peptidomimetics and non-peptide analogs conjugated to nitric oxide donor and the like, and mixtures thereof.

In certain embodiments, the antiplatelet agent has short to ultra short half-life. By short or ultra short half life is meant that the antiplatelet agent is cleared from circulation within 15 minutes to 8 hours after the infusion of the antiplatelet agent into the patient is stopped.

In one embodiment, the antiplatelet agent is an active agent that binds to or associates with the GPIIb/IIIa sites in a reversible manner and has a circulating half-life of inhibition of 4 hours or less. Short to ultra-short acting GPIIb/IIIa antagonist might include eptifibatide, tirofiban, DUP728, abciximab (Reopro), lefradafiban, sibrafiban, orbofiban, xemilofiban, lotrafiban, XJ757, and XR299 (Class II).

Non-steroidal anti-inflammatory drugs (NSAIDS) are commonly available, and typically are used for treating inflammation. Generally, NSAIDS can have a salicylate-like or non-salicylate structure. NSAIDS suitable for the invention can be salicylate-like or non-salicylate NSAIDS that bind reversibly and inhibit platelet aggregation in vitro, but are cleared rapidly, i.e. quickly eliminated from the body, when infused (typically, in less than about 2 hours). NSAIDS suitable for the invention include, but are not limited to, for example, salicylate-like NSAIDS, such as acetaminophen, carprofen, choline salicylate, magnesium salicylate, salicylamide, sodium salicylate, sodium thiosulfate, and the like, and mixtures thereof. Examples of non-salicylate NSAIDS include, but are not limited to, diclofenac sodium, diflunisal, etodolac, fenoprofen calcium, flurbiprofen, hydroxychloroquin, ibuprofen, indomethacin, ketoprofen, ketorolac tromethamine, meclofenamate sodium, mefenamic acid, nabumetone, naproxen, naproxen sodium, oxyphenbutazone, phenylbutazone, piroxicam, sulfinpyrazone, sulindac, tolmetin sodium, dimethyl sulfoxide, and the like, and mixtures thereof.

In addition, any agent that inhibits chemical pathways within the platelets leading to reduction in platelet activation is suitable for the invention. Typically, agents that inhibit chemical pathways leading to reduced platelet activation are calcium sequestering agents, such as calcium channel blockers, α-blockers, β-adrenergic blockers, and the like, and mixtures thereof. More specific examples of calcium sequestering agents include, but are not limited to, anticoagulant citrate dextrose solution, anticoagulant citrate dextrose solution modified, anticoagulant citrate phosphate dextrose solution, anticoagulant sodium citrate solution, anticoagulant citrate phosphate dextrose adenine solution, potassium oxalate, sodium citrate, sodium oxalate, amlodipine, bepridil hydrochloride, diltiazem hydrochloride, felodipine, isradipine, nicardipine hydrochloride, nifedipine, nimodipine, verapamil hydrochloride, doxazocin mesylate, phenoxybenzamine hydrochloride, phentolamine mesylate, prazosin hydrochloride, terazosin hydrochloride, tolazoline hydrochloride, acebutolol hydrochloride, atenolol, betaxolol hydrochloride, bisoprolol fumarate, carteolol hydrochloride, esmolol hydrochloride, indoramine hydrochloride, labetalol hydrochloride, levobunolol hydrochloride, metipranolol hydrochloride, metoprolol tartrate, nadolol, penbutolol sulfate, pindolol, propranolol hydrochloride, terazosin hydrochloride, timolol maleate, guanadrel sulfate, guanethidine monosulfate, metyrosine, reserpine, and the like, and mixtures thereof.

The antiplatelet agent can be used in conjunction with a pharmaceutically acceptable oxygen carrier. The oxygen carrier can be any suitable red blood cell substitute. Typically, the oxygen carrier is an acellular hemoglobin-based oxygen carrier substantially free of red cell membrane (stroma) contaminants. The term “pharmaceutically acceptable oxygen carrier” as used herein refers to a substance that has passed the FDA human safety trials at a hemoglobin dosage of 0.5 g/kg body weight or higher. An oxygen carrier suitable for the invention can be hemoglobin, ferroprotoporphyrin, perfluorochemicals (PFCs), and the like. The hemoglobin can be from human or any other suitable mammalian source. In a preferred embodiment, the preservative composition has a hemoglobin concentration from the range of 1 to 18 gm/dl and a methemoglobin concentration of less than about 5%. The hemoglobin based oxygen carrier will be chemically modified to mimic the oxygen loading and unloading characteristics of fresh red blood cells. Additionally, the chemical modification will enhance the buffering capacity of the preferred embodiment and preserve normal physiologic pH.

The amount of the antiplatelet agent present in the preservative composition depends on the type of antiplatelet agent. The amount of antiplatelet agent is sufficient to reversibly inhibit binding to a ligand or site on the platelet in a manner that is sufficient to inhibit platelet function, when bound. For GPIIb/IIIa inhibitors, suitable amounts in the preservative composition are about 0.5 mg to about 3 mg for 50 ml of acellular hemoglobin-based oxygen carrier substantially free of red cell membrane (stroma) contaminants. NSAIDs, for example, ibuprofen, are present in the preservative composition in an amount of about 20 mg to about 60 mg for each 50 ml of acellular hemoglobin-based oxygen carrier that is substantially free of red cell membrane contaminants.

The preservative composition of the present invention may further comprise a short-to-ultra-short acting broad spectrum anti-microbial agent. By short or ultra short acting anti-microbial agent is meant that the agent is cleared from circulation within 15 minutes to 8 hours after the infusion of the antimicrobial into the patient is stopped. Examples of such agents include, but are not limited to, the agents listed below:

1. Penicillin—a group of antibiotics produced either by Penicillium (natural penicillins) or by adding side chains to the β-lactam ring (semisynthetic penicillins).

2. Natural penicillins—the first agents of the penicillin family that were produced; ex: penicillins G and V.

3. Semisynthetic penicillins—modifications of natural penicillins by introducing different side chains that extend the spectrum of antimicrobial activity and avoid microbial resistance.

4. Monobactam—a synthetic antibiotic with a β-lactam ring that is monocyclic in structure.

5. Cephalosporin—an antibiotic produced by the fungus Cephalosporium that inhibits the synthesis of gram-positive bacterial cell walls.

6. Carbapenems—antibiotics that contain a β-lactam antibiotic and cilastatin.

7. Vancomycin—an antibiotic that inhibits cell wall synthesis.

8. Isoniazid (INH)—a bacteriostatic agent used to treat tuberculosis.

9. Ethambutol—a synthetic antimicrobial agent that interferes with the synthesis if RNA.

10. Aminoglycoside—an antibiotic consisting of amino sugars and an aminocyclitol ring, such as streptomycin.

11. Tetracycline—a broad-spectrum antibiotic that interferes with protein synthesis.

12. Chloramphenicol—a broad-spectrum bacteriostatic chemical.

13. Macrolide—an antibiotic that inhibits protein synthesis, such as erythromycin.

14. Rifamycin—an antibiotic that inhibits bacterial RNA synthesis.

15. Quinolone—an antibiotic that inhibits DNA replication by interfering with the enzyme DNA gyrase.

16. Fluoroquinolone—a synthetic antibacterial agent that inhibits DNA synthesis.

17. Sulfonamide—a bacteriostatic compound that interferes with folic acid synthesis by competitive inhibition.

18. Synergism—the principle whereby the effectiveness of two drugs used simultaneously is greater than that of either drug used alone.

19. Polyene antibiotic—an antimicrobial agent that alters sterols in eucaryotic plasma membranes and contains more than four carbon atoms and at least two double bonds.

20. Imidazole—an antifungal drug that interferes with sterol synthesis.

21. Triazole—an antifungal antibiotic used to treat systemic fungal infections.

22. Griseofulvin—a fungistatic antibiotic.

The platelet preservation composition can be used in any setting that requires the circulation of blood outside the body such as in patients undergoing open heart surgery, renal dialysis, plasmapheresis, and other procedures requiring platelet supplementation.

The inactivated, functional platelets can be in the form of whole blood, a platelet-containing component of whole blood, or isolated platelets substantially free of red blood cells and other blood nutrients.

The preservative composition can be directly added to a blood collection bag, or be kept in a separate bag and combined with the blood after collection. The blood in the collection bag optionally can be treated with an anticoagulant. In a typical setting, the preservative composition is added directly to the blood collection bag.

Typically, the blood is whole blood isolated from a mammal, for use in the same species. In the case of a human, the blood is isolated and separated into the three core components of whole blood, i.e., plasma, cells, and platelets. The whole blood, or only the platelet component of the whole blood, can be treated with the preservative composition. If whole blood is treated, a preferred embodiment contemplates the use of only some components of the proposed preservative composition, such as the antiplatelet agent and anticoagulant, for whole blood storage. The blood can then be fractionated and the platelet component can be further mixed with the preservative composition of the present invention for storage.

Functional activities of platelets are determined by their ability to aggregate in the presence of certain biological agents and their morphology. Platelet function also can be assessed by the maintenance of the pH upon limited storage of a solution containing the platelets and in vivo haemostatic effectiveness using the rabbit kidney injury model described in Krishnamurti et al., Transfusion, 39:967 (1999). Structural integrity of platelets is assessed by in vivo survival following radiolabeling with carbon-15 or indium-111 and identification of the presence of specific platelet antigens.

The preservative composition of the present invention is used in an amount of about 60 to about 200 ml for about one unit of platelets (typically about 80 to about 100 ml of platelets). Alternatively, the preservative composition of the present invention is combined with about one unit of whole blood, typically about one pint, and separated into various components to afford about one-sixth to about one-tenth whole blood unit of treated platelets.

In one embodiment, the preservative composition contains an antiplatelet agent dissolved in about 45 to about 55 ml of an oxygen carrier. When used with a unit of whole blood, the antiplatelet agent can also be dissolved in about 45 to about 55 ml of normal saline to preserve the freshness of the platelets without an oxygen carrier. The selection of an antiplatelet agent and an oxygen carrier, and the determination of the amounts for including such components in the preservative composition, are within the capability of, or can be readily determined by, those skilled in the art of preparing preserved platelet compositions.

The use of a hemoglobin-based oxygen carrier, even in small volumes, as part of the preservative solution provides significantly greater concentration of oxygen than amounts currently made available by the use of oxygen-permeable storage bags. The combination of platelets with an oxygen carrier (e.g., a stroma-free hemoglobin solution) allows the use of gas impermeable bags, which reduces the high cost associated with using gas permeable bags.

The preserved platelets are stored at low temperature. In one embodiment, the platelets are stored at −20° C. to 12° C. In another embodiment, the platelets are stored at 0° C. to 12° C. In another embodiment, the platelets are stored at 4° C. to 12° C. In yet another embodiment, the platelets are stored at 4° C. to 8° C.

Prior to the clinical use of the preserved platelets, the inhibitors of platelet activation or aggregation in the preserved platelets are removed by diafiltration. Diafiltration is a membrane based separation that can be used to remove small molecule contaminant from a process liquid or dispersion. In one embodiment, the diafiltration uses a hollow fiber filter.

By using the preservative method of the invention, the platelet function also can be better maintained throughout the 5-day storage period mandated by the FDA. The platelets can be stored at low temperature. In one embodiment, the platelets are store at −20° C. to 12° C.; preferably in the range of 0° C. to 12° C.; more preferably in the range of 4° C. to 12° C., and most preferably in the range of 4° C. to 8° C.

The platelets used in the invention can be sterilized by chemical sterilization, radiation, or a combination thereof, in the presence of the preferred embodiment. For example, the platelets can be sterilized by chemical filtration; ultraviolet radiation, such as UVA, UVB, and UVC; gamma-radiation; ionizing radiation, such as x-ray radiation; or by using a chemical as a photosensitizer. Methods for sterilizing platelets are well known in the art and include, for example, the methods described in U.S. Pat. Nos. 5,798,238; 5,869,701; 5,955,256; 5,981,163; 6,030,767; 6,087,141; and 6,106,773.

The present invention is further illustrated by the following examples which should not be construed as limiting. The contents of all references, patents and published patent applications cited throughout this application, as well as the Tables are incorporated herein by reference.

The foregoing examples illustrate that an acellular preservative solution for freshly collected platelets can be prepared for improving the functional half-life of platelets. The addition of the preservative solution to freshly collected platelets better maintains the original blood clotting function when infused during the storage period of the platelets. The addition of a preservative solution permits an extended storage of the platelets at low temperatures, and allows the platelets to maintain blood clotting properties without affecting the half-life of the platelets in circulation once transfused. As a result, the platelets stored for an extended period can be used for transfusions while saving a substantial amount of effort and cost.

### Example 1

### General Procedure of Preparing the Preservative Solution Containing Antiplatelet

In 50 ml of an acellular chemically modified hemoglobin-based carrier substantially free of red cell membrane (stroma) contaminants, with a hemoglobin concentration of 12-20 gm/dl and a methemoglobin concentration of less than 5%, the following active ingredients were added:

1) A GPIIb/IIIa inhibitor, such as eptifibatide (INTEGRILIN®, Schering-Plough Corporation, Kenilworth, N.J., U.S.A.), XJ757, DUP728, XR299 or aggrastat (tirofiban) in an amount of 0.001-5.0 mg.

2) An anti-inflammatory drug (NSAID), such as ibuprofen, in an amount of 20-60 mg.

The above preservative solution can be added either to the blood collection bag containing the anticoagulant or to a separately attached bag. If the platelets are going to undergo a sterilizing procedure, chemical or radiation, then the preservative composition is either added prior to sterilization or added in a separately attached bag.

3) A short to ultra-short acting Xa inhibitor such as DX-9065a, BX-80783, RPR-120844 or an Xa inhibitor from the SEL-series or other short acting Xa inhibitor in an amount of 0.001-5 mg.

4) An energy source such as glucose or citrate to sustain aerobic metabolism

5) Electrolytes such as Na, Cl, and Mg.

TABLE 1 provides the concentration ranges for some commonly used energy sources and electrolytes.

TABLE 1
Commonly Used Energy Sources and Electrolytes

| Component | Concentration (mM) |
|---|---|
| NaCl | 80 to 120 |
| KCl | 5 to 15 |
| MgCl₂/MgSO₄ | 2 to 5 |
| Na₂ Citrate | 5 to 40 |
| NAH₂PO₄/Na₂HPO₄ | 5 to 30 |
| Na Acetate | 20 to 40 |
| Na Gluconate | 15 to 30 |
| Glucose | 20 to 50 |
| Maltose | 25 to 35 |
| D-Mannitol | 25 to 40 |

### Example 2

### In Vitro Assessment of Platelet Function and Stability

Cell counts in the platelet concentrates and mean platelet volume were determined electronically using a particle counter. The pH, pO₂, pCO₂, and bicarbonate levels were determined in a blood gas analyzer. Glucose, lactic acid, and lactic dehydrogenase levels in the platelet concentrates were measured by standard clinical chemistry methodology. Platelet function was measured by aggregometry using ADP and collagen as agonists and by thrombelastography (TEG).

### Thrombelastography (TEG)

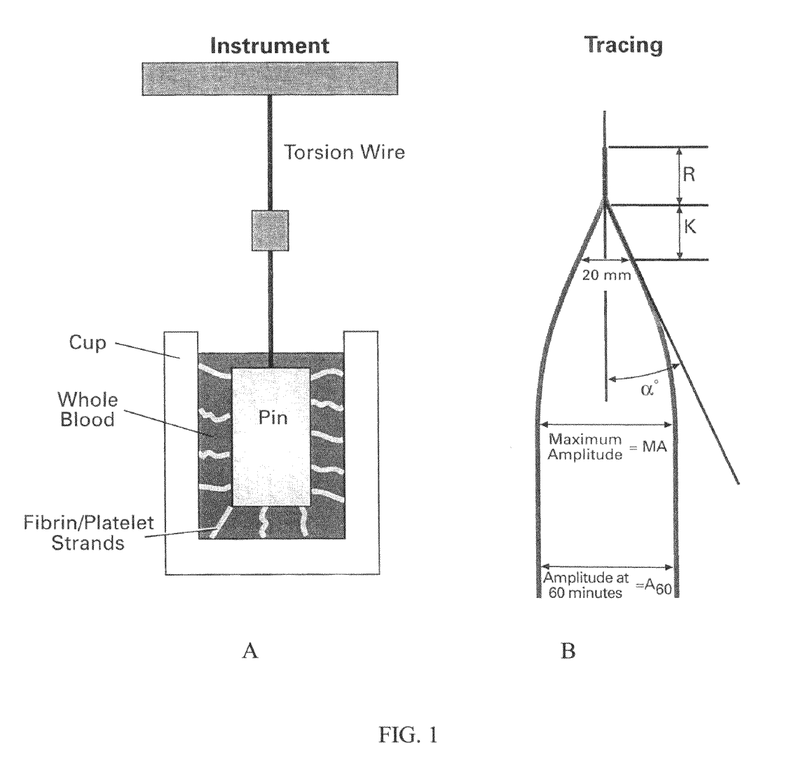

The principle of TEG is based on the measurement of the physical viscoelastic characteristics of blood clot. Clot formation was monitored at 37° C. in an oscillating plastic cylindrical cuvette (“cup”) and a coaxially suspended stationary piston (“pin”) with a 1 mm clearance between the surfaces, using a computerized Thrombelastograph (TEG Model 3000, Haemoscope, Skokie, Ill.). The cup oscillates in either direction every 4.5 seconds, with a 1 second mid-cycle stationary period; resulting in a frequency of 0.1 Hz and a maximal shear rate of 0.1 per second. The pin is suspended by a torsion wire that acts as a torque transducer. With clot formation, fibrin fibrils physically link the cup to the pin and the rotation of the cup as affected by the viscoelasticity of the clot (Transmitted to the pin) is displayed on-line using an IBM-compatible personal computer and customized software (Haemoscope Corp., Skokie, Ill.). The torque experienced by the pin (relative to the cup's oscillation) is plotted as a function of time (FIG. 1).

TEG assesses coagulation by measuring various parameters such as the time latency for the initial initiation of the clot (R), the time to initiation of the fixed clot firmness (k) of about 20 mm amplitude, the kinetic of clot development as measured by the angle (α), and the maximum amplitude of the clot (MA). The parameter A measures the width of the tracing at any point of the MA. Amplitude A in mm is a function of clot strength or elasticity. The amplitude on the TEG tracing is a measure of the rigidity of the clot; the peak strength or the shear elastic modulus attained by the clot, G, is a function of clot rigidity and can be calculated from the maximal amplitude (MA) of the TEG tracing.

The following parameters were measured from the TEG tracing (FIG. 1):

R, the reaction time (gelation time) represents the latent period before the establishment of a 3-dimensional fibrin gel network (with measurable rigidity of about 2 mm amplitude).

Maximum Amplitude (MA, in mm), is the peak rigidity manifested by the clot.

Shear elastic modulus or clot strength (G, dynes/cm²) is defined by: G=(5000A)/(100−A).

Blood clot firmness is important function parameters for in vivo thrombosis and hemostasis because the clot must stand the shear stress at the site of vascular injury. TEG can assess the efficacy of different pharmacological interventions on various factors (coagulation activation, thrombin generation, fibrin formation, platelet activation, platelet-fibrin interaction, and fibrin polymerization) involved in clot formation and retraction.

### Blood Sampling

Blood was drawn from consenting volunteers under a protocol approved by the Human Investigations Committee of William Beaumont Hospital. Using the two syringe method, samples were drawn through a 21 gauge butterfly needle and the initial 3 ml blood was discarded. Whole blood (WB) was collected into siliconized Vacutainer tubes (Becton Dickinson, Rutherford, N.J.) containing 3.8% trisodium citrate such that a ratio of citrate whole blood of 1:9 (v/v) was maintained. TEG was performed within 3 hrs of blood collection. Calcium was added back at a final concentration of 1-2.5 mM followed by the addition of the different stimulus. Calcium chloride by itself at the concentration used showed only a minimal effect on clot formation and clot strength.

### Statistical Analysis

Data are expressed as mean±SEM. Data were analyzed by either paired or group analysis using Student's t-test or ANOVA when applicable; differences were considered significant at P<0.05 or less.

Effect of GPIIb/IIIa Antagonists c7E3 (Long Acting Versus Short/Ultra Short Acting) on Tissue Factor Mediated Clot Retraction in Human Whole Blood Thrombelastography

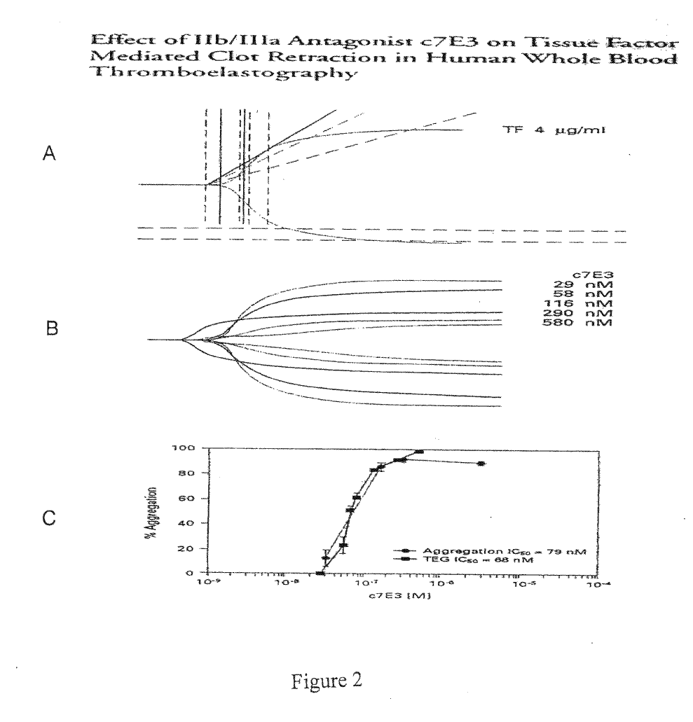

Increasing concentrations of GPIIb/IIIa antagonists impaired the rate of increase in G force developed without prolonging R by tissue factor (TF)-activated whole blood clots. FIGS. 2A-2C are representative tracings showing efficacy of GPIIb/IIIa antagonist c7E3 in inhibiting TF-mediated clot formation under shear use of TEG.

### Determination of Dissociation Rates

To determine platelet/GPIIb/IIIa ligand dissociation rate (t_{1/2}), platelet rich plasma samples were treated for 60 minutes with 0.04 μM of ³H-Roxifiban or the various Roxifiban isoxazoline analogs including XR299, DMP802, and XV454. Following this 60-minute incubation period, the tubes were centrifuged for 10 minutes (150×g). The resulting ³H-radioligand/platelet rich plasma (PRP) complex was carefully removed and centrifuged for an additional 10 minutes (1,500×g). The resulting platelet poor plasma (PPP) was removed and the platelet pellet re-suspended (1.6×10⁸/ml) in fresh PPP. Five hundred microliters of this suspension was transferred to wells of a 24-well plate (blocked with 5% bovine serum albumine (BSA)). To initiate dissociation, dilution with 1.0 ml Tris buffer, pH 7.4 containing 100 μM non-radiolabeled ligand was added to the wells. At designated time points (0-60 minutes), the ³H-GPIIb/IIIa antagonist/PRP complex was removed from the wells. For GPIIb/IIIa antagonists with fast platelet dissociation rate the t_{1/2} (min.) for the dissociation of platelet bound ³H-GPIIb/IIIa antagonists was carried out at short intervals. The resulting platelet pellet was counted using a liquid scintillation counter. CPMs recovered are compared to the control (t=0) and presented as percent bound per 0.8×10⁸ platelets over time. The t½ for the platelet dissociation of short to ultra-short acting GP IIb/IIIc antagonists including Integrilin, Tirofiban, XR299, XV454, XV457 ranged from 0.05-0.25 minutes (Table 3). As used herein, the term “short-to-ultra-short” refers to the half life of the compound that is based on (i) in vitro displacement results as shown in Table 3 and is based on (ii) in vivo half life after the infusion of the preserved platelets, which is less than 4 hours in human.

### Radiolabel/Platelet Elution Profile

### Preparation of Gel Columns and Platelets

About 200 ml of gel slurry (Sepharose-CL4B, #17-0150-01, Pharmacia) was placed in a large buchner funnel and washed with 1 liter of distilled water. The washed gel was reconstituted with water to form a thick slurry. Two columns were prepared by loading about 120 ml of the washed gel slurry to each column (Siliconize column with Sigma-Cote, Sigma Chemical #SL-2; or Bio-Rad Column #737-2531). One column was used to determine platelet counts, while the other was used to determine CPMs. The packed columns were washed with 250 ml of distilled water, followed with 150 ml of HBMT through the gel to allow buffer/gel equilibration.

Human whole blood is collected via venupuncture as described above and placed in intovacutainers containing 0.5 ml of 0.1M buffered sodium citrate (Becton/Dickinson). The whole blood was centrifuged for 10 minutes at 150×g (˜1000 rpm Sorvall RT6000). The PRP was collected and kept in a capped polypropylene tube until use.

### Radiolabeling and Platelet Elution

3.5 ml of PRP was incubated with either a radiolabeled ligand or a cold ligand for 15 minutes at 22° C. The PRP was then carefully loaded onto a Sepharose gel column and eluted with Hepes Buffered Modified Tyrodes Solution (HBMT, see Table 2)) and collect 60, 2 ml fractions (total volume=˜120 ml) from each column.

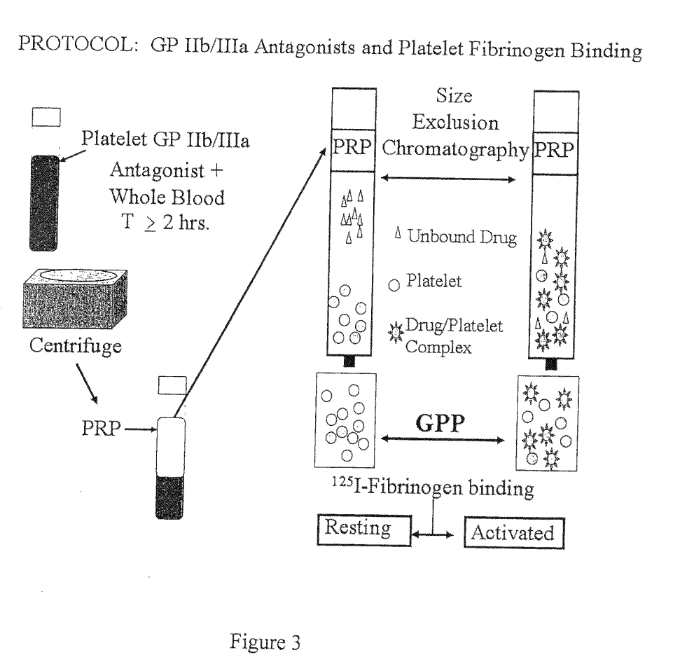

Non radioactive fractions were counted on a coulter counter (T540), in order to determine platelet counts. 250 μl of the radiolabeled elutions from each fraction were counted on a beta counter (Packard Minaxi Tri-Carb). The labeling/eluting process is summarized in FIG. 3.

TABLE 2
Hepes Buffered Modified Tyrodes Solution (HBMT)

| CHEMICAL | [M] | g/l |
|---|---|---|
| NaCl | 0.14 | 8.2 |
| KCl | 0.0027 | 0.201 |
| NaH₂PO₄ + H₂O | 0.0004 | 0.055 |
| NaHCO₃ | 0.012 | 1.0 |
| GLUCOSE | 0.0055 | 0.991 |
| BSA fraction-V | | 3.5 |
| HEPES | 0.005 | 1.192 |

NOTE:
pH 7.4 at 22° C.

Table 3 shows dissociation rates of short acting (e.g. XR290) and long acting (e.g. c7E3) GPIIb/IIIa antagonists to human platelet.

TABLE 3

| | Long acting | | | Short to ultra-short acting | | | |
|---|---|---|---|---|---|---|---|
| Binding Parameters | XV459 | XV454 | c7E3 | DMP728* | XR290* | Tirofiban* | Integrilin* |
| Dissociation Rates | 7.0 | 32.0 | 40.0 | 0.2 | 0.05 | 0.1 | 0.25 |
| (t½ - Minutes) | | | | | | | |

In vitro t½ of 0.1 minute translate to 30 minutes washout in vivo in animals or human, t½ of 7 minutes translate into 20-24 hours washout in vivo in animals or human, and t½ of 30-40 minutes translate to washout of 7-10 days (the life time of the platelet in the circulation).

For platelet preservation, a short to ultra-short GPIIb/IIIa antagonists will be the preferred ones.

### Effect of Biovec Preservative Solution on Platelet Function and Stability

Platelets were collected by the buffy coat method according to standard Blood Bank procedure. Platelet concentrates (PCs) thus obtained and were split into two units. The first split unit (control sample) was stored in a control solution (Intersol platelet additive solution from Fenwal Inc., Lake Zurich, Ill.) containing approximately 30% plasma. The second split unit (test sample) was stored in the Biovec preservative solution.

On Day 2 and Day 7, the standard QC was performed. Additionally, platelet functionality tests were conducted by Thromboelastography (TEG) and with the Multiplate Analyzer. The former measures clot strength (MA) and reaction time, and is an indicator of the platelet response to activation in the presence of kaolin. The latter measures the platelets response to agonists such as Collagen and thrombin related activated peptide (TRAP). The inhibitors of platelet activation (i.e., antiplatelets and anticoagulant) in the Biovec preservative were removed by diafiltration prior to platelet functionality tests. Briefly, the inhibitors were removed by a four volume exchange against Intersol containing approximately 20% fresh frozen plasma. This was accomplished by using a hollow fiber filter (X20S-300-0.2N from Spectrum Labs, Rancho Dominguez, Calif.). The exchange was carried out prior to the testing of the samples.

During the testing period, the oxygenation, pH, glucose consumption and lactate production of the control sample and test sample were well within the acceptable limits.

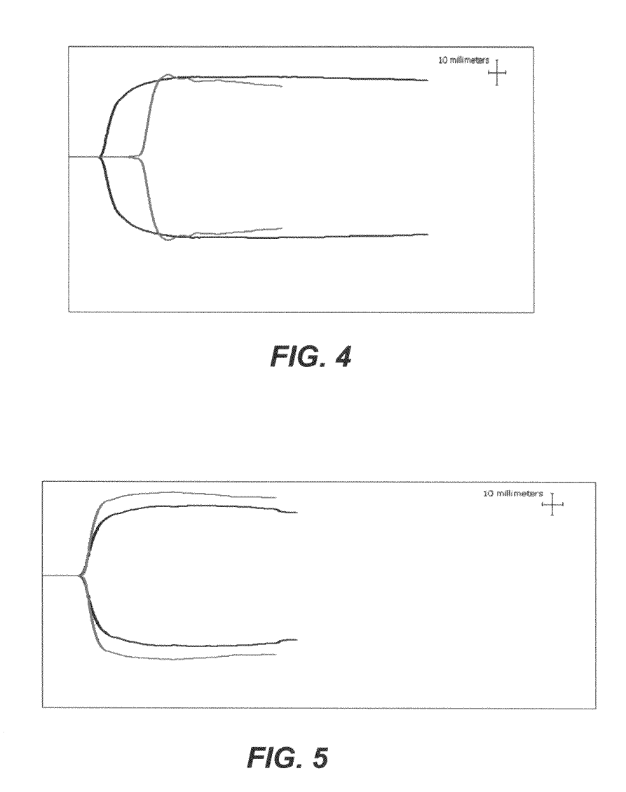

On Day 2, all functionality tests were comparable between the control and test samples. Results from the two samples are shown in FIGS. 4 and 5. In FIG. 4, the reaction time R of the test sample was 50% longer than that of the control sample. This is a reflection of the presence of residual inhibitors in the test sample. It was determined that approximately 3 to 5% of starting concentration of the inhibitors was still present in the test sample after the diafiltration process. FIG. 5 shows data following one day of storage of a second set of split platelet concentrate units. The control is again represented by the black tracing and the test unit by the green tracing. In this instance there has been complete removal of the platelet inhibitors. Furthermore, platelets stored with the Biovec preservative demonstrate a stronger clot than the control. This suggests that the inhibitors affect both the reaction time as well as the clot strength.

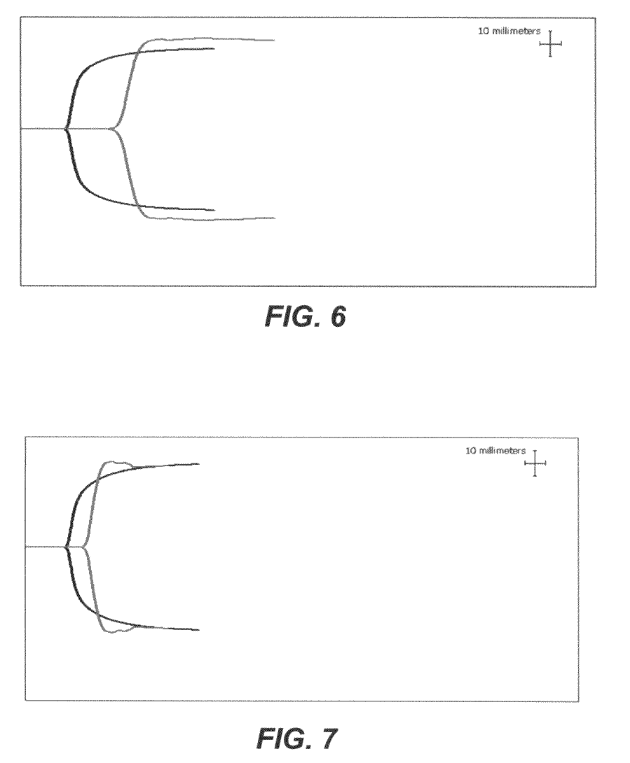

On Day 7, the MA or clot strength on the TEG indicates that the control sample formed a significantly weaker clot compared to the test sample. This finding was further confirmed with the Multiplate analyzer. As shown in FIGS. 6 and 7, the test sample showed clear response to agonists (similar to the response at Day 2), whereas the control sample showed minimal to no response.

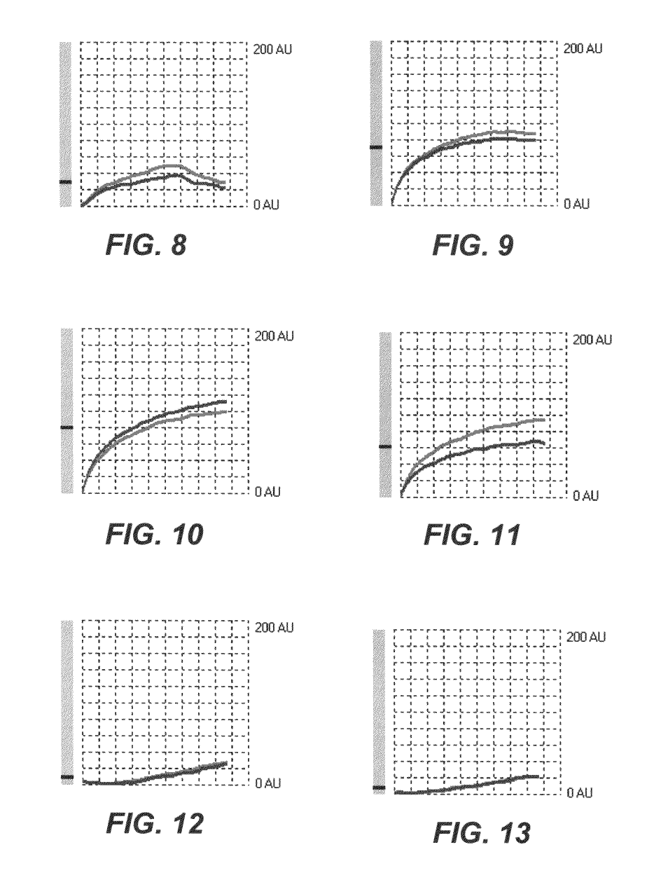

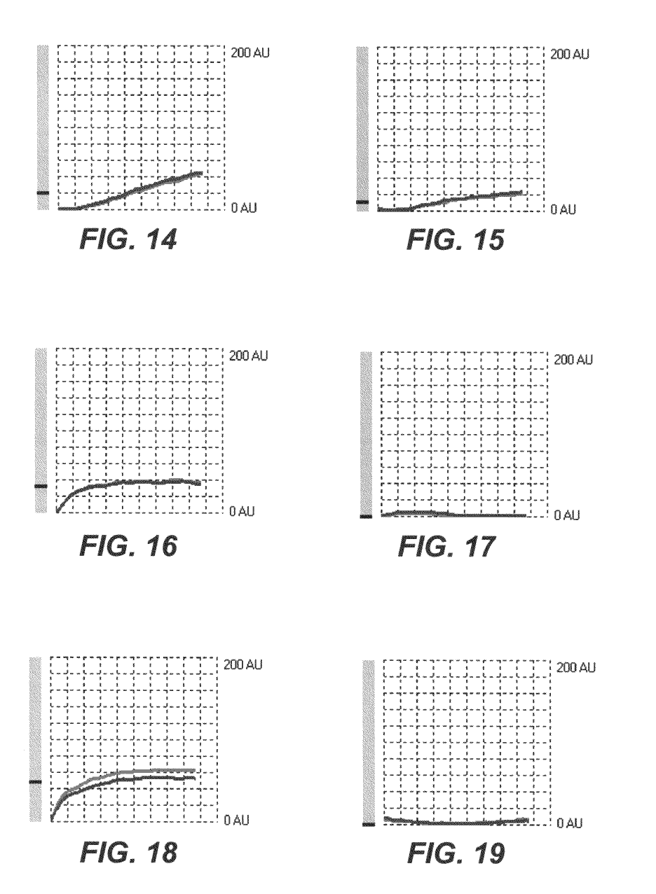

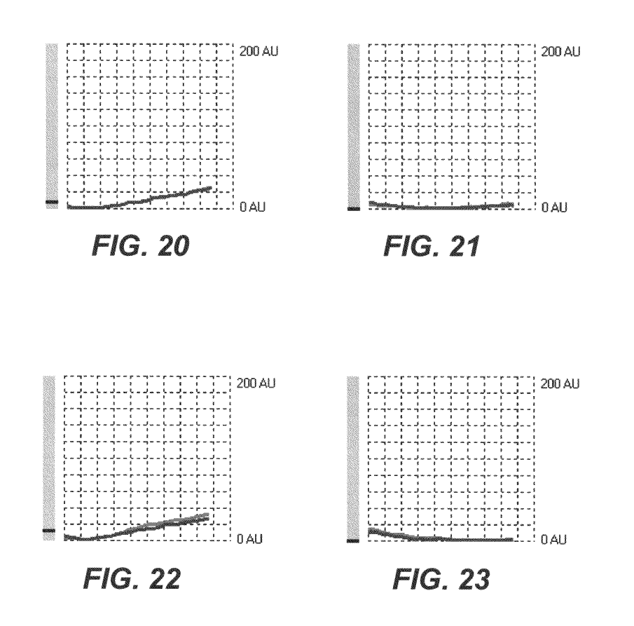

These results indicate that platelets stored in Biovec preservative solution were able to respond to stimulus significantly better than platelets preserved in currently available solutions. This finding is confirmed by the platelet responses to thrombin related activated peptide (TRAP) and collagen (FIGS. 8-20).

Accordingly, the data presented clearly demonstrates that platelets stored in the Biovec preservative solution:

(1) formed a stronger clot even in the presence of some leftover inhibitors from the Biovec preservative, both after one day of storage and following 7 days of storage. This is a clear reflection of better maintenance of platelet intra cellular structure and metabolism;

(2) showed a strong response to commonly used agonists such as TRAP and collagen. In sharp contrast, platelets stored in one of the commonly used preservative solution, had no response to the same agonists.

### Effect of Cold Storage on Platelet Function and Stability

Platelets were collected by the buffy coat method following standard blood bank procedures. Briefly, whole blood unit collected from a donor is suspended overnight for cell separation to occur by gravity. The whole blood unit is separated into packed red blood cells, the buffy coat and plasma. The buffy coat is passed through a leukoreduction filter to remove the white blood cells and collect the platelets. Following the collection, 4 pooled platelet units were split into two separate units. One half was stored at room temperature in currently used preservative solution, again according to current regulatory requirements. The second half of the split unit was stored in the Biovec preservative solution at low temperature (2-12° C. with reciprocal shaking, as is done for standard platelet units. Samples were drawn aseptically from all units on Day 2, 5 and 7 of storage. Standard Quality control requirements were conducted on all units. This involves measuring, pH, pCO₂, glucose consumption, lactate production and platelet counts.

The platelets stored at low temperatures demonstrated comparable metabolic activity compared to the controls both on Day 2, 5 and 7, establishing their viability. Furthermore, the pH was identical, even after 7 days of storage in the cold (pH7.09), which meets regulatory transfusion requirements.

As shown in Table 4, the platelet counts on Day 5 were down 24% from Day 2 for the refrigerated platelets, compared to 20% for platelets stored at room temperature. The platelet counts on Day 7 were down 33% from Day 2 for the refrigerated platelets, compared to 25% for room temperature stored platelets. This difference is not viewed as clinically significant.

The platelets stored at low temperature in the Biovec preservative solution demonstrated very acceptable storage characteristics and would be suitable for transfusion.

Because room temperature storage of platelet significantly increases the risk of bacterial contamination, the FDA has limited the storage time of platelets to 5 days. The limited storage time frequently leads to a shortage of platelets for treating trauma and cancer patients. Platelets stored at the low temperature in the Biovec preservative solution of would significantly alleviate this problem.

TABLE 4
Effect of cold storage on platelet function and stability

| | mml/L | Glucose | mml/L | Lactate | kPa | PLO₂ | 22° C. | PH | CT × 10⁹/L | PLT |
|---|---|---|---|---|---|---|---|---|---|---|
| DAY 2 | — | 7.2 | — | 4.6 | — | 3.0 | — | 7.32 | — | 193.8 |
| R.T. | X | 7.3 | X | 4.9 | X | 3.0 | X | 7.33 | X | 188.3 |
| | 7.325 | 7.2 | 4.68 | 4.7 | 2.9 | 2.7 | 7.34 | 7.34 | 177.8 | 158.2 |
| | | 7.6 | | 4.5 | | 2.7 | | 7.37 | | 171.2 |
| COLD | — | 7.2 | — | 4.6 | — | 2.8 | — | 7.32 | — | 189.6 |
| | X | 7.3 | X | 4.8 | X | 3.0 | X | 7.33 | X | 182.6 |
| | 7.325 | 7.0 | 4.68 | 4.7 | 2.7 | 2.6 | 7.34 | 7.35 | 173.5 | 155.4 |
| | | 7.6 | | 4.6 | | 2.5 | | 7.37 | | 166.5 |
| DAY 5 | — | 1.5 | — | 14.1 | — | 1.7 | — | 7.13 | — | 154.0 |
| R.T. | X | 1.4 | X | 14.1 | X | 1.8 | X | 7.15 | X | 152.6 |
| | 1.05 | 0.2 | 14.8 | 16.0 | 1.7 | 1.5 | 7.10 | 7.05 | 143.3 | 126.2 |
| | | 1.2 | | 14.9 | | 1.7 | | 7.08 | | 140.3 |
| COLD | — | 1.4 | — | 14.2 | — | 1.7 | — | 7.11 | — | 144.3 |
| | X | 1.3 | X | 14.1 | X | 1.7 | X | 7.15 | X | 143.7 |
| | 1.13 | 0.5 | 14.8 | 16.3 | 1.7 | 1.5 | 7.10 | 7.07 | 132.7 | 114.7 |
| | | 1.3 | | 14.4 | | 1.8 | | 7.08 | | 128.2 |

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the claimed components and steps in any sequence which is effective to meet the objectives there intended, unless the context specifically indicates the contrary.

What is claimed is:

1. A method for preserving platelets, comprising:
admixing inactivated, functional platelets with a preservative composition comprising an effective amount of one or more pharmaceutically acceptable inhibitors of platelet activation to form preserved platelets;
storing the preserved platelets at a low temperature; and
removing the one or more inhibitors of platelet activation from the preserved platelets by diafiltration prior to transfusion,
wherein said low temperature is in the range of about −20° C. to 12° C.

2. The method of claim 1, wherein said one or more inhibitors of platelet activation comprise an anticoagulant and an antiplatelet agent.

3. The method of claim 2, wherein said antiplatelet agent is capable of binding to, or associating with a GPIIb/IIIa receptor site.

4. The method of claim 2, wherein said antiplatelet agent is selected from the group consisting of DUP728, XJ757, XR299, eptifibatide, orbofiban, xemilofiban, Lamifiban, tirofiban (Aggrastat), and mixtures thereof.

5. The method of claim 2, wherein said antiplatelet agent is selected from the group consisting of linear and cyclic RGD analogs.

6. The method of claim 5, wherein said linear and cyclic RGD analogs are conjugated to a nitric oxide donor.

7. The method of claim 2, wherein said antiplatelet agent has a circulating half-life of inhibition of about less than 4 hours.

8. The method of claim 2, wherein said antiplatelet agent comprises GPIIb/IIIa inhibitor at a concentration of about 0.2 μg/ml to about 0.1 mg/ml.

9. The method of claim 2, wherein said antiplatelet agent comprises GPIIb/IIIa inhibitor at a concentration of about 10 μg/ml to about 60 μg/ml.

10. The method of claim 2, wherein said anticoagulant is a compound that reversibly inhibits factor Xa, or factor IIa, or both.

11. The method of claim 10, wherein said anticoagulant is a short-to-ultrashort acting Xa inhibitor with a circulating half-life of less than 4 hours.

12. The method of claim 10, wherein said anticoagulant is selected from the group consisting of DX-9065a, BX-80783, RPR-120844, and short-to-ultrashort acting Xa inhibitors.

13. The method of claim 10, wherein said anticoagulant is a short-to-ultrashort acting IIa inhibitor selected from the group consisting of hirudin, hirulog, melgatran, and combinations thereof.

14. The method of claim 10, wherein said anticoagulant is a combination of at least one short-to-ultrashort acting IIa inhibitor, and at least one short-to-ultrashort acting Xa inhibitor.

15. The method of claim 2, wherein said antiplatelet agent is a compound that binds to or associates with GPIIb/IIIa sites, and wherein the anticoagulant is a factor Xa inhibitor, a factor IIa inhibitor, or a combination of both.

16. The method of claim 1, wherein said preservative composition further comprises an oxygen carrier.

17. The method of claim 16, wherein said oxygen carrier is selected from the group consisting of hemoglobin, ferroprotoporphyrin, perfluorochemicals, and mixtures thereof.

18. The method of claim 17, wherein said oxygen carrier is a hemoglobin-based oxygen carrier.

19. The method of claim 18, wherein said hemoglobin-based oxygen carrier is substantially free of red cell membrane contaminants.

20. The method of claim 16, wherein said mixture is stored in an oxygen-permeable bag.

21. The method of claim 16, wherein said mixture is stored in an oxygen-impermeable bag.

22. The method of claim 1, wherein said preservative composition further comprises a short-to-ultrashort acting broad spectrum anti-microbial agent selected from the group consisting of: Penicillin, Natural penicillins, Semisynthetic penicillins, Monobactam, Cephalosporin Carbapenems Vancomycin, Isoniazid (INH), Ethambutol, Aminoglycoside, Tetracycline, Chloramphenicol, Macrolide, Rifamycin, Quinolone, Fluoroquinolone, Sulfonamide, Synergism, Polyene antibiotic, Imidazole, Triazole, Griseofulvin and combinations thereof.

23. The method of claim 1, wherein said low temperature is in the range of about 0° C. to about 12° C.

24. The method of claim 1, wherein said low temperature is in the range of about 4° C. to about 12° C.

25. The method of claim 1, wherein said low temperature is in the range of about 4° C. to about 8° C.
